(19) United States
(12) Patent Application Publication
(10) Pub. No.: US 2021/0201423 A1
(43) Pub. Date: Jul. 1, 2021

(54) SYSTEM AND METHOD FOR MONITORING INSURANCE CLAIMS AND DETECTING FRAUD AND COMMUNICATION THEREOF

(71) Applicant: inAssist Health Management Solutions, Torrance, CA (US)

(72) Inventors: Scott Michael Speranza, Franklin, TN (US); Theodore M. Newman, New York, NY (US)

(21) Appl. No.: 17/201,819

(22) Filed: Mar. 15, 2021

Related U.S. Application Data
(63) Continuation-in-part of application No. 15/960,190, filed on Apr. 23, 2018.
(60) Provisional application No. 62/989,408, filed on Mar. 13, 2020.
(60) Provisional application No. 62/569,454, filed on Oct. 6, 2017.
(60) Provisional application No. 62/488,847, filed on Apr. 23, 2017.

(51) Int. Cl. G06Q 40/08; G06Q 10/10; G06F 3/048

(52) U.S. Cl. CPC G06Q 40/08; G06F 3/048; G06Q 10/10

(57) ABSTRACT

A computer-implemented method of verifying claim data comprising receiving the claim data having a claim associated therewith from a data source, analyzing the claim to assess the accuracy thereof, sending a verification request to an insured associated with the claim requesting that the insured verify the accuracy of selected portions of the claim, receiving verification information from the insured in response to the verification request, and then programmatically assessing the verification information from the insured. If the insured verifies the accuracy of the selected portions of the claim, programmatically updating a profile associated with the insured to include the verification information, and then programmatically sending authorization instructions regarding payment of the claim. If the insured does not verify the accuracy one or more portions of the selected portions of the claim, then programmatically initiating a fraud investigation of the portions of the claim that are inaccurate.

### RELATED APPLICATION

The present application claims priority to U.S. provisional patent application Ser. No.: 62/989,408, entitled SYSTEM AND METHOD FOR MONITORING INSURANCE CLAIMS AND DETECTING FRAUD AND COMMUNICATION THEREOF, which was filed on Mar. 13, 2020, and is a continuation-in-part patent application of U.S. patent application Ser. No. 15/960,190, entitled SYSTEM AND METHOD FOR EFFECTING HEALTH INSURANCE CLAIM BENEFIT AND FRAUD ANALYSIS AND COMMUNICATION THEREOF, which was filed on Apr. 23, 2018, and claims the benefit of Provisional Application No.: 62/488,847, which was filed on Apr. 23, 2017, and of Provisional Application No.: 62/569,454, which was filed on Oct. 6, 2017. The contents of which are herein incorporated by reference.

### BACKGROUND OF THE INVENTION

The present invention is directed to a claims monitoring system and method that is capable of determining and finding find fraudulent use of a person's insurance to obtain medical services, treatment or prescription drugs. In addition, the insurance theft can occur when an individual's personal information is fraudulently used to bill insurance providers for services that were not provided.

In 2018, $3.6 trillion was spent on health care in the United States, representing billions of health insurance claims. It is an unfortunate reality that some of these claims were fraudulent. Although they constitute only a small fraction of the overall money spent on healthcare, these fraudulent claims carry a very high price tag—both financially and in how they impact our perception of the integrity and value of our health care system.

The National Health Care Anti-Fraud Association (NHCAA) estimates that the financial losses due to health care fraud are in the tens of billions of dollars each year. A conservative estimate is 3% of total health care expenditures, while some government and law enforcement agencies place the loss as high as 10% of our annual health outlay, which equates to more than $300 billion annually.

### SUMMARY OF THE INVENTION

The present invention is directed to a system and method for real-time health care insurance claim monitoring and fraud analysis by a third party monitoring system and includes automated and/or semi-automated procedures to collect, store and analyze insured data, claim data, health data and health insurance claim data provided from health care insurers to determine if the insurance claim is fraudulent or not. The system and method can be configured to send alerts associated with for example detected fraud, billing errors, and application of claim benefits. Various embodiments are disclosed and are optionally comprised of one or more computer systems for retrieval, storage and analysis of the medical claim data and automated notification of the same to the insured. Accordingly, it is an object of the present invention to provide rapid and efficient monitoring of claim data, such as health insurance claims,

According to one aspect, the present invention is directed to a computer-implemented method of verifying claim data comprising receiving the claim data having a claim associated therewith from a data source, analyzing the claim to assess the accuracy thereof, sending a verification request to an insured associated with the claim requesting that the insured verify the accuracy of selected portions of the claim, receiving verification information from the insured in response to the verification request, programmatically assessing the verification information from the insured, if the insured verifies the accuracy of the selected portions of the claim, programmatically updating a profile associated with the insured to include the verification information, and then programmatically sending authorization instructions regarding payment of the claim, and if the insured does not verify the accuracy one or more portions of the selected portions of the claim, then programmatically initiating a fraud investigation of the portions of the claim that are inaccurate. The data source can be from an insurance data provider or a medical service provider, and can include insurance data, insured data, healthcare data, or any combination thereof.

The method can also include receiving registration data from the insured and storing the registration data in the profile. The registration data can include insured data that includes identification information, insurance data that includes insurance company information that is handling insurance for the insured, and login credentials including a user identification. During the fraud investigation, the method can also include analyzing the claim data and the verification information to determine whether the claim is accurate and to determine whether fraudulent activity has occurred.

The method of the present invention also can be configured to reverify selected data to ensure the accuracy of the information received from the insured. As such, the method of the present invention can also include reverifying the claim data with the insured so as to confirm that the verification information is accurate. The method of can also include auditing the claim based on the results of the fraud investigation. The auditing portion of the method can include verifying the claim data associated with the claim by contacting the service provider and the insurance company to determine the accuracy of the claim data.

The method of the present invention can also include providing a mobile software application that is configured for via a user interface generator generating a first request interface in response to the verification request. The first request interface displays the selected portions of the claim data and a plurality of selectable soft buttons that requests selected information from the insured. A first one of the plurality of soft buttons when actuated transmits the verification information indicating that the selected portions of the claim are accurate, and a second one of the plurality of soft buttons when actuated transmits the verification information indicating that selected portions of the claim are inaccurate.

Further, when the first one of the plurality of soft buttons is actuated, generating a second request interface for displaying confirmation information confirming selections made by the insured and at least one second soft button such that when actuated the second request interface display additional information associated with the claim. When the second one of the plurality of soft buttons is selected, generating a third request interface with the user interface generator for displaying the selected portions of the claim data including service provider information. The method also includes requesting additional verification information from the insured, and displaying a plurality of third soft buttons having a first soft button for allowing when actuated the insured to confirm selection of one or more of the service providers and a second soft button for allowing when actuated the insured to indicate that one or more the service providers is inaccurate. When the second soft button of the plurality of third soft buttons is actuated, generating a fourth request interface with the user interface generator for displaying message information concerning the claim and the fraud investigation and one or more fourth soft buttons that when selected displays additional information about the fraud investigation. The method also includes generating a fifth user interface for displaying selected claim information and requesting reverification of the claim information.

Still further, when the fraud investigation is initiated, generating a fraud interface with the user interface generator for displaying selected fraud information associated with the fraud investigation, wherein the fraud information includes a plurality of steps and the fraud interface displays the selected steps of the fraud investigation that have been completed.

The present invention is also directed to a non-transitory computer-readable storage medium (e.g., software application stored in suitable memory) storing instructions that when executed causes one or more processors to generate a first request interface in response to a verification request, wherein the first request interface displays selected portions of claim data about an insured and a plurality of selectable soft buttons that requests selected information from the insured, and wherein a first one of the plurality of soft buttons when actuated transmits verification information indicating that the selected portions of the claim are accurate, and when a second one of the plurality of soft buttons is actuated transmits the verification information indicating that selected portions of the claim are inaccurate. When the first one of the plurality of soft buttons is actuated, generating a second request interface for displaying confirmation information confirming selections made by the insured and at least one second soft button such that when actuated the second request interface display additional information associated with the claim. Further, when the second one of the plurality of soft buttons is selected, generating a third request interface for displaying the selected portions of the claim data including service provider information, and then requesting additional verification information from the insured. The method can also involve displaying a plurality of third soft buttons having a first soft button for allowing when actuated the insured to confirm selection of one or more of the service providers and a second soft button for allowing when actuated the insured to indicate that one or more the service providers is inaccurate. When the second soft button of the plurality of third soft buttons is actuated, generating a fourth request interface for displaying message information concerning the claim and the fraud investigation and one or more fourth soft buttons that when selected displays additional information about the fraud investigation.

The non-transitory computer-readable storage medium can also include generating a fifth user interface for displaying selected claim information and requesting reverification of the claim information. Further, when the fraud investigation is initiated, generating a fraud interface with the user interface generator for displaying selected fraud information associated with the fraud investigation, and wherein the fraud information includes a plurality of steps and the fraud interface displays the selected steps of the fraud investigation that have been completed.

### BRIEF DESCRIPTION OF THE DRAWINGS

The present disclosure is illustrated and described herein with reference to various drawings, in which like reference numbers are used to denote like system components/method steps, as appropriate; and optional series of process operations are shown in dashed outlines and connector lines such that a first series of steps used in a first optional series is shown in a first type of dashed outlines and connectors, while a second series of steps used in a second optional series is shown in a second type of dashed outlines and connectors. The present disclosure is to be interpreted with reference to but not limited by the various drawings in which:

FIG. 1 is a block diagram schematic representation of the claim monitoring system of the present invention.

FIG. 2 is a schematic representation of the claim monitoring agency unit of the claim monitoring system of FIG. 1 according to the teachings of the present invention.

FIGS. 3A-3C are schematic flow chart diagrams of the communication of claim data between an insurance data provider unit and the claim monitoring agency unit of the claim monitoring system of the present invention.

FIGS. 4A and 4B are user interfaces generated by a user interface generator of a software application stored on an electronic device illustrating the communication between the insured and the claim monitoring agency unit when a claim is received by the claim monitoring agency unit from the insurance data provider unit, and subsequent verification of the claim data by the insured, according to the teachings of the present invention.

FIGS. 5A and 5B are user interfaces generated by the user interface generator when the claim data sent to the insured is reviewed thereby and considered to be inaccurate according to the teachings of the present invention.

FIG. 6 is a user interface generated by the user interface generator when the claim data is exchanged between the insured and the claim monitoring agency unit for re-verification according to the teachings of the present invention.

FIGS. 7A-7D are user interfaces generated by the user interface generator displaying various notifications sent to the insured when fraud is detected in the claim data according to the teachings of the present invention.

FIG. 8 is a schematic diagram of an electronic device and/or associated system suitable for implementing the process flow identification system of the present invention.

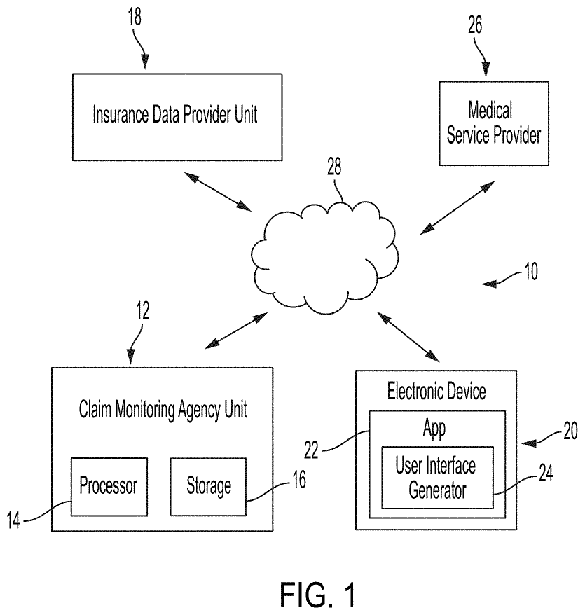

### DETAILED DESCRIPTION

The following disclosure provides descriptions of various implementations, or embodiments, or merely alternatives of the system and method of this disclosure including alternative embodiments of various aspects of the present disclosure. It is to be understood that various alternatives presented for different aspects of the invention are to be considered disclosed in combination with each individual alternative present for other aspects of the invention.

For the purposes of this specification and the appended claims, unless otherwise indicated, all numbers expressing quantities of ingredients, percentages or proportions of materials, reaction conditions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters, setting forth a broad scope of the embodiments of the present disclosure, are approximations, the numerical values set forth in the specific examples are reported as precisely as practical. Any numerical value, however, inherently contains certain errors necessarily resulting from the standard deviation found in their respective testing measurements, or variations in application thereof. Moreover, all ranges disclosed herein are to be understood to encompass any and all sub-ranges subsumed therein. For example and not limitation, a range of “1 to 10” includes any and all sub-ranges between (and including) the minimum value of 1 and the maximum value of 10, that is, any and all sub-ranges having a minimum value of equal to or greater than 1 and a maximum value of equal to or less than 10, e.g.: 5.5 to 10; 5.5 to 9.5; or 1 to 9.5.

It is noted that, as used in this specification and the appended claims, the singular forms “a,” “an,” and “the,” include plural referents unless expressly and unequivocally limited to one referent. Thus, for example and not limitation, reference to “a member” includes one, two, three or more members.

It is to be further understood that all disclosure of immediate connections between elements (including physical members, electrical or computer devices, or operations (steps) of a process or method) of the present disclosure are intended to positively disclose direct connections without intervening elements, but are not intended to exclude incorporation of intervening elements unless specifically related in claim language. Similarly, it is to be understood that with regard to methods and flowcharts herein, a disclosure of operations directly following one another, or a disclosure of steps wherein a first step directly follows a second step, is intended to positively disclose direct sequential following without intervening operations, but is not intended to exclude intervening operations unless explicitly related in claim language.

Reference will now be made in detail to various embodiments of the present disclosure, examples of which are illustrated in the accompanying drawings. While the embodiments of the present disclosure are described in conjunction with the illustrated embodiments, it will be understood that they are not intended to limit the invention to those embodiments. On the contrary, the invention is intended to cover all alternatives, modifications, and equivalents, which may be included within the invention as defined by the appended claims.

As used herein, the term “claim data” or “insurance claim data” is related to any type of data associated with or referencing a claim (e.g., an insurance claim) or request for payment made by a service provider to an insurance company for services rendered in connection with an insured and covered by an insurance policy. The claim data can include a request for payment for any selected types of goods or services, including for example healthcare or health related services, and can further include, as part of the claim, insurance data, insured data, healthcare data, a description of the services rendered by the service provider, and the like.

As used herein, the term “insurance data” is intended to include any selected type of data associated with or related to any type of insurance policy or insurance product that covers the insured, including for example health insurance, dental insurance and the like. The insurance data can include the insurance company identification information and other related information, policy or insurance identification information, a description of the types of services covered by the insurance, a description of the services rendered by the service provider, a description of the healthcare or medical professionals covered by the insurance, policy limit information, benefit information, co-pay amounts covered by the insurance, and the like.

As used herein, the term “insured” is intended to mean any selected person or organization that is covered by insurance or an insurance policy from an insurance provider.

As used herein, the term “health data” or healthcare data” is intended to include any types of goods or services that is associated with or related to the health or general or specific care of the insured or any types data related to the health or healthcare of the insured. Examples of suitable types of medical care related information, health or healthcare related data include patient information (e.g., insured data), descriptions of visits with medical or healthcare professionals, medical tests or screening, medical procedures, medical operations, drugs, medicines, medical service or procedure information, medical personnel related information (e.g., doctor related information), cost information, billing information, as well as insured data and the like.

As used herein, the term “healthcare professional” or “medical professional” is intended to include any selected type of person or employee that is affiliated with or employed by a healthcare facility, healthcare institution such as a hospital, or healthcare location (e.g., clinic) that renders healthcare related services. Examples of suitable healthcare professionals include doctors, nurses, physician assistants, health aides, technicians including lab technicians, dentists, dental assistants, hygienists, and the like.

As used herein, the term “insured data” includes any selected type of personal information associated with the insured, including for example any selected type of identification information. Examples of suitable identification information can include name, address, telephone numbers, date of birth, social security number, driver's license number, insurance policy number, medical data, and the like.

As used herein, the term “module” or “unit” used either alone or with other terms, in its broadest sense, refer to any suitable hardware, software, or combinations thereof that can further include subroutines, functions, background programs, software objects, or any other type of software code that is configured to effect a given function in combination with other programming elements. The storage elements or units and memory elements or units described herein are directed to storing code (e.g., compiled and optionally source code) which implements operation of various components, referred to as modules or units herein that operate in concert to effect operation of the system of the present invention.

The present invention is directed to a claim monitoring system 10 that monitors claim data including health insurance claims and related healthcare data for accuracy and to monitor, identify and remediate fraudulent activity. The illustrated claim monitoring system 10 includes a claim monitoring agency unit 12 that receives and monitors data, including claim or insurance data, insured data, healthcare data, insurance data, and the like. The claim monitoring agency unit 12 can take selected action based on the data. The illustrated claim monitoring agency unit 12 can include a controller or processor 14 for processing selected types of data, and a storage unit 16 for storing the data. The storage unit 16 can include any selected type and number of storage elements, including for example one or more databases or memory elements, for storing the data. The storage element can be fully contained within the claim monitoring agency unit 12 or can be distributed throughout the system 10. Alternatively, the system can employ suitable cloud hosting services, such Microsoft Azure and Amazon Web Services (AWS), for hosting and storing the data. The claim monitoring system 10 can also include an insurance data provider unit 18, a medical service provider unit 26 and an electronic device 20 that can selectively communicate with each other via a network 28. The illustrated network 28 can be a private network, a public network, or a combination of both. The network 28 may be connected via wired or wireless links to the various components or units of the claim monitoring system 10, and may be any type and/or form of network. The geographical scope of the network 28 may vary widely and the network can be a body area network (BAN), a personal area network (PAN), a local-area network (LAN), e.g. Intranet, a metropolitan area network (MAN), a wide area network (WAN), or the Internet. The topology of the network 28 may be of any form and may include, e.g., any of the following: point-to-point, bus, star, ring, mesh, or tree. The network 28 may be an overlay network, which is virtual and sits on top of one or more layers of other networks. The network 28 may be of any such network topology as known to those ordinarily skilled in the art capable of supporting the operations described herein. The network 28 can include in some embodiments one or more logically-grouped servers or the servers may be geographically dispersed. The server 28 may be a file server, application server, web server, proxy server, appliance, network appliance, gateway, gateway server, virtualization server, deployment server, SSL VPN server, or firewall, or any other suitable computing or electronic device. The network can include or employ any suitable types or number of electronic devices including for example servers, client computers, switches, routers, controllers, processors, and the like.

The claim monitoring system 10 can also include an insurance data provider unit 18 that can store and hence provide to the claim monitoring agency unit 12 claim data as well as healthcare data and insured data. The claim monitoring agency unit 12 can also communicate via the network with an electronic device 20 for exchanging information therewith. The electronic device 20 can be any suitable computing type apparatus, such as a computer, server, client device, tablet, laptop, personal digital assistant (PDA), smart phone and the like. The electronic device 20 can have any suitable software application 22 associated therewith. The software application can have a user interface generator 24 associated therewith for generating user interfaces for display on the display of the electronic device. According to one embodiment, the electronic device can be a smartphone, and the software application 22 can be a suitable mobile software application that enables the electronic device to exchange information with the claim monitoring agency unit 12. The claim monitoring agency unit 12 can also communicate with one or more different types of medical service providers 24 for exchanging therebetween suitable healthcare data related to or concerning a good or service performed on behalf of the insured.

The claim monitoring system 10 of the present invention thus provides a service to the insured by facilitating access by the insured to claim data and by providing claim analysis and updates, including fraud updates, to the insured. The system 10 can thus monitor, analyze, process and communicate claim data, insurance data, healthcare data, insured data, and other related data in accordance with the methods described herein.

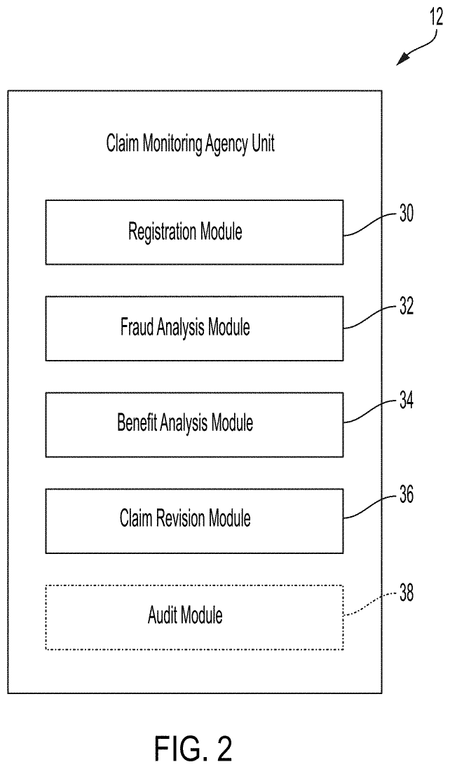

The claim monitoring agency unit 12 can also include a number of modules or units for effecting or performing a number of selected functions and services related to the present invention. For example, as shown in FIG. 2, the claim monitoring agency unit 12 can include a registration module 30 for registering the insured with the system 10. The registration process can be effected in a number of different ways, such as by the insured using a suitable electronic device, such as a computer, to go to a selected website, and registering with the system by providing selected insured data. Alternatively, the insured can employ the software application 22 stored on an electronic device 20, such as a smartphone, to register with the system by providing selected information, including insured data that includes the insured's name, address, and other related information. The registration module 30 effects operations to accept input such as registration information provided by the insured who has contracted to have the claim monitoring system 10 monitor transactions for the insured. The input may include insured data, such as identification information, insurance data including at least one insurance company handling health insurance for the insured, and login credentials optionally including a user identification (ID). The user ID is optionally the name of the insured, a randomly select name or alphanumeric and/or symbolic combination, an email address of the insured, a biometric input, or other indicia. It is also envisioned that the insured may not have previously logged onto the insurer's web portal. In such a case, it is understood that the insured provides relevant information such as, for example and not limited to, selected identification and insurance data or information including name, policy number, insurer name, and other information as may be required to effect an initial registration of the insured. The registered module 30 can communicate with the storage element 16 so that the registration module 30 can store selected registration data or information therein.

The claim monitoring agency unit 12 can also include a fraud analysis module 32 to monitor, analyze and process the claim data, insurance data, healthcare data, and/or insured data to determine or inquire whether a claim made on behalf of the insured is accurate and to determine whether fraudulent activity has occurred. There are many known implementations and types of fraud monitoring and known types of fraud, some of which are described herein.

The claim monitoring agency unit 12 can also include a benefit analysis module 34 for analyzing the benefits associated with a selected insurance policy of the insured. The benefit analysis module 34 operates by referencing data stored in the storage element 16 or provided thereto by the insurance data provider unit 18 either via an insurance company's web portal, over the network 28, or otherwise. The claim data or insurance data provides data associated with the various benefits provided by the different policies offered by the insurance company in question and related to the insured. Subsequently, claim data is compared against the benefits of an insurance policy of the insured, and a determination is made as to whether the insured is achieving good usage of their benefits. The claim monitoring system 10 of the present invention can take remedial action if benefits are not being properly utilized. One way of accomplishing this goal is via operation of a claim revision module 36, which takes output from the benefit analysis module 34 and compares the benefit data against predetermined claim revision requests to find a matching format request which is then automatically prepared, and which may be filed electronically with an insurance company or insurer or a medical service provider to see if a better usage of insurance benefits exists.

The claim monitoring system 10 can also employ an optional audit module 38 for auditing the claim data provided by the insurance data provider unit 18. The audit module 38 can initiate an audit of the claim data based on information received from the insured in response to selected requests for input and the claim data. The audit can involve verifying or re-verifying that the data associated with the submitted claim is accurate. The audit can include or involve contacting the medical service providers 24 and the insurance companies to determine the accuracy of the claim data. The audit can be performed electronically, manually or both. The audit module 38 is illustrated as forming part of the claim monitoring agency unit 12, but those of ordinary skill will readily recognize that the audit module can also be a stand alone unit or can be integrated into one or more of the other units or modules of the claim monitoring system 10.

The storage element 16 can include one or more databases or other known types of storage elements for storing insurance data and insured data. Other types and forms of data may also be stored in the storage element to effect functioning equivalent to that of the present disclosure. The insurance data can include for example company address, phone number, policy types, and/or a website portal data (URL). Insurance company portal profile data can also be stored in the storage element 16 or provided by the insurance data provider unit 18 and can include data used to optionally harvest at least claim data from an insurance company web portal and optionally includes any of the following: member ID, website URL, login credentials, claim data URL, HTML Tag/ID for detailed claim data, a site map which includes URLs with various paths which are associated with data types that may be access via a given path, and/or a map of field data used to transfer data to the claim monitoring agency unit 12. Further provided can be insurance company email profile data, which is data used in optionally harvesting claim data from email and/or text messages sent by an insurer. The email profile data includes data relating to various email formats used by a given insurer and maps of various data fields in the email to the storage element 16 along with any selected key words and/or symbols or characters contained in a given email which are useful to extracting data. For example, the word “procedure” may be identified either in a sentence or a table from which the claim monitoring agency unit 12 optionally keys on to extract data. Still further included is insurance data which may disclose various policies and the benefits included therein, where the data can be used by the benefit analysis module 34 to determine the benefits of the insured and whether the benefits are being properly utilized.

The insured data can also include insured's login/contact data used to access the insurance companies web portal, policy data used to identify pertinent policies contained in the insurance data, insured benefit data, which is derived from the insurance policy data based on the insurance data and used to determine whether benefits are being properly applied, and claim data which can be optionally harvested from the insurance company web portal and optionally includes the insured's claim history, which facilitates both fraud and benefit analysis conducted by the fraud analysis module 32 and the benefits analysis module 34.

As is known in the art, healthcare fraud and abuse can take many forms. From the perspective of the insurance companies or service providers, the most common of types of fraud include service providers billing for services that were not provided to the insured, duplicate submission of a claim for the same service, misrepresentation of the services provided, service providers charging for a more complex or expensive service than what was actually provided (e.g., upcoding), and service providers billing for a covered service when the service actually provided was not covered. From the insureds perspective, the most common forms of fraudulent activity include a person using a member ID card that does not belong to that person, the insured or a another party improperly adding someone to a policy that is not eligible for coverage (e.g., grandchildren), the insured failing to remove someone from a policy when that person is no longer eligible (e.g., a former spouse), or the insured visiting multiple doctors to obtain multiple prescriptions.

The claim monitoring system 10 can be programmed and configured to monitor, detect, analyze, assess, and then take action if a fraudulent incident, event, or activity is detected. The system 10 can be configured to monitor for and detect warnings signs for fraud, such as for example an insured receiving a bill for a medical service that the insured did not receive, the insured being contacted by a debt collector about a medical debt that was not properly incurred, a credit report of the insured includes health care expenditures that are not recognized, the insured receives an explanation of benefits (EOB) from an insurer that includes medical data regarding services that the insured did not receive, or the insured is contacted by their insurance company to notify them that they have reached their policy limits when the insured has not received sufficient services to reach the policy limit. The system 10 of the present invention can help reduce the incidence of insurance fraud with regard to medical claims by proactively identifying fraud early in the claim process; employing a systematic process of monitoring a member's insurance policies; using the claim monitoring agency unit 12 to collect, organize and analyze claim data, and then flagging or identifying an unknown service provider; and investigating unknown service providers or visits programmatically or by trained auditors working closely with service providers and insurance carriers and companies.

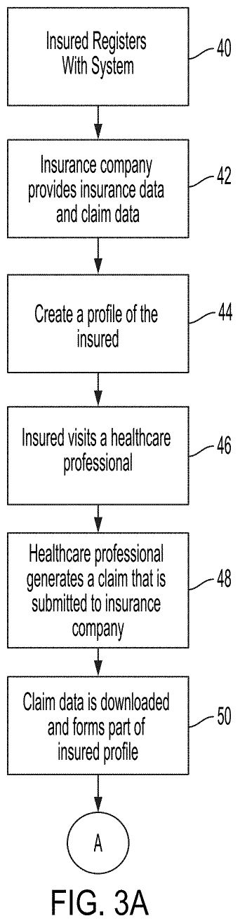

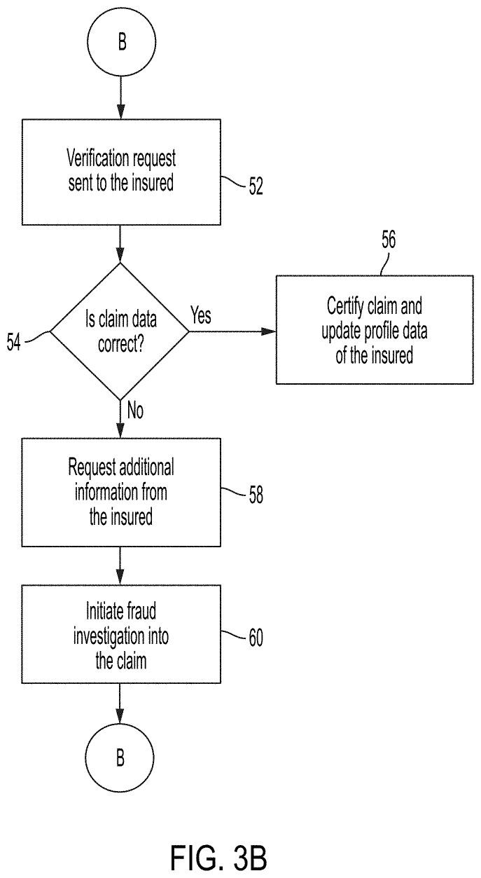

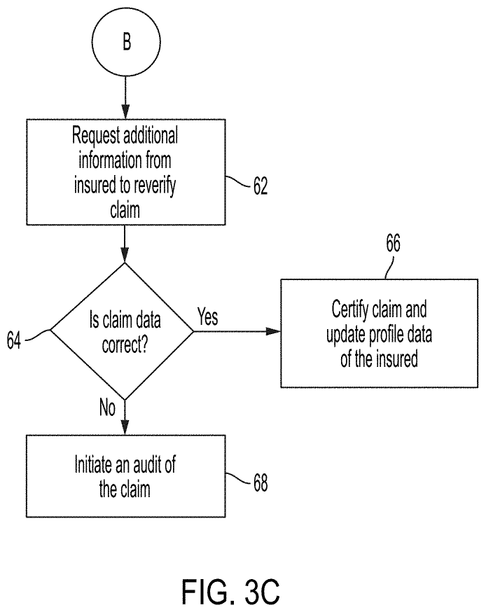

Accordingly, the claim monitoring system 10, and specifically the claim monitoring agency unit 12, and associated method of the present invention can interface or communicate with a user via the electronic device 20, such as for example a smart phone. FIGS. 3A-3C illustrate the method for receiving processing, analyzing and then talking action based on the receipt by the claim monitoring agency unit 12 of claim data. As shown for example in FIG. 3A, the insured can register with the system 10 via the electronic device 20. During the registration process, the insured can provided insured data as well as insurance data that is processed by the registration module 30 of the claim monitoring agency unit 12, step 40. The registration of the insured also enables the claim monitoring agency unit 12 to communicate with the proper insurance company via the appropriate insurance data provider unit 18. According to one embodiment, each insurance data provider unit 18 that communicates with the claim monitoring agency unit 12 can be associated with a specific insurance company. The insurance data provider unit 18 can provide selected insurance data and claim data to the claim monitoring agency unit 12 that can be stored in the storage element 16 and processed by the processor 14, step 42. The insurance data can include policy type and associated information and the claim data can include date that includes information about any selected goods or services that have allegedly been performed or purchased on behalf of a selected insured and which a claim for reimbursement has been filed with the insurance company. The insurance data and the claim data can be processed by the processor 14. The claim monitoring agency unit 12 can then construct, generate or create a profile on the insured that includes the selected insured data, claim data, any associated healthcare data, information about any associated healthcare professional, and insurance data, step 44.

The insured can then visit a healthcare professional at a medical service provider 24 to have a selected medical service performed, such as for example and for purposes of illustration, a check-up or the like, step 46. The medical service provider 24 can then in turn generate and submit a claim for reimbursement for services to the insurance data provider unit 18 (e.g., insurance company) that is covering the insured, step 48. The insurance claim information can include healthcare data such as medical related information, medical service or procedure information, medical personnel related information (e.g., doctor related information), cost information, billing information, as well as insured data and the like. The insurance data provider unit 18 processes the claim data associated with the claim submitted by the medical service provider unit 24 and can then forward to the claim monitoring agency unit 12 the claim data as well as any related insurance data, insured data, and healthcare data. The data that is exchanged between the insurance data provider unit 18 and the claim monitoring agency unit 12 can form part of the profile of the insured, step 50. The claim data can be processed by multiple different modules of the claim monitoring agency unit 12, including for example by the claim revision or processing module 36, the benefit analysis module 34, the fraud analysis module 32, or the audit module 38, or any combinations thereof.

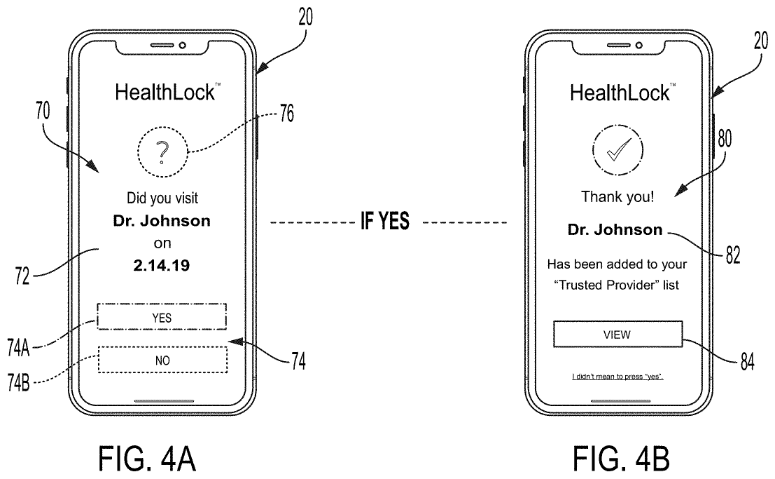

As shown in FIG. 3B, once the claim data submitted by the medical service provider unit 24 is processed by the insurance data provider unit 18 and then sent to the claim monitoring agency unit 12, the claim monitoring agency unit 12 sends selected information, such as verification data, which includes various types of notices, updates, and requests for information, to the electronic device 20 associated with the insured, step 52. The verification data can include a verification request that requests the insured to verify the accuracy of selected information sent to the electronic device. The software application 22 stored on the electronic device 20 can be executed and can include a user interface generator 26 for generating one or interfaces for display on a display portion of the electronic device 20. According to one embodiment, the user interface generator 26 can generate a first request interface 70 for requesting the insured to verify the accuracy of selected claim data so as to be able to determine if fraud has occurred, step 54. FIG. 4A is an example of the first request interface 70 generated by the user interface generator 26. The first request interface can display selected claim data 72 associated with a service provided by a medical service provider. By simple way of example, the claim data can include information about a doctor visit, and can display identification information about the doctor, such as name and address, and can display the date the service was provided as well as an amount charged by the medical service provider to the insurance company. The first request interface 70 can also provide one or more selectable soft buttons 74 that requests selected information from the insured. For example, the soft buttons 74 can include a verification or Yes soft button 74A and a decline or No soft button 74B, step 54. The interface can also include any selected type of visual indicia 76 that is intended to convey to the viewer (e.g., the insured) that information is being requested by the first request interface 70. In the current example, the visual indicia can include a question mark so as to convey to the insured that a question is being asked that requires a response by the insured. Those of ordinary skill in the art will readily recognize that the indicia 76 can include any selected type of symbols, numbers, letters, words, pictures, or combinations thereof. The insured can review the claim data 72 displayed in the first request interface 70, and if the claim data is correct, the insured can select the soft button 74A to confirm the accuracy of the claim data. The selection of this button 74A indicates that the insured is verifying that the claim data is accurate and correct. If the soft button 74A is selected, then the software application 22 via the hardware and software of the electronic device 20 communicates with the claim monitoring agency unit 12, and if desired the fraud analysis module 32, and the profile data of the insured is updated to include the claim data. Specifically, the claim monitoring agency unit 12 can communicate with the insurance data provider unit 18 that the claim has been verified and not fraudulent. In response, the insurance data provider unit 18 can certify the claim, and if desired, pay the amount of the claim. The insurance data provider unit 18 can also communicate with the insured either directly or via the claim monitoring agency unit 12 that the claim has been paid or is scheduled for payment, or to provide any other selected information associated with the claim.

Further, when the soft button 74A is selected, the user interface generator 26 generates a second request interface 80 that displays selected portions of the claim data 82 that the claim monitoring agency unit 12 desires the insured to review or displays confirmation information that confirms the selections that were entered by the insured. In the current example, the claim data can include listing any selected type of data associated with the medical provider, such as the doctor name and other associated information. The second request interface 80 can also request the insured to verify or select any portion of the displayed information for further processing by the fraud analysis module 32. As illustrated, the second request interface can communicate that selected information has been added to the insured profile as a trusted provider. Further, the interface 80 can include a selectable soft button 84 that when actuated the interface can display additional information associated with the claim, medical provider, and the like, step 56.

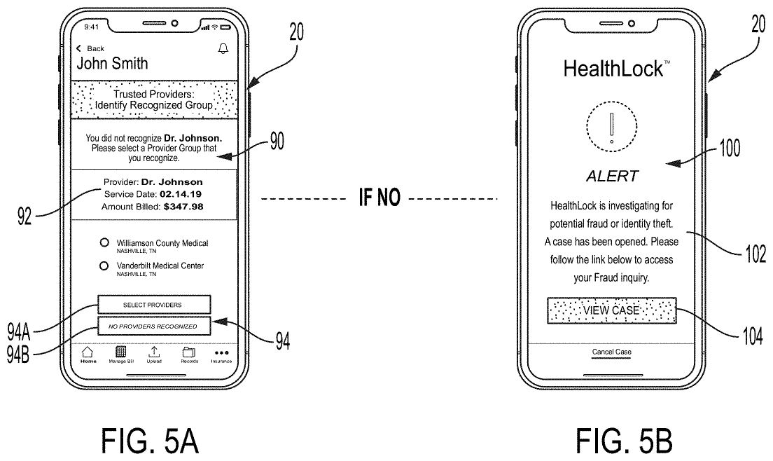

If the insured selects the No soft button 74B, then the user interface generator 26 of the application 22 generates a third request interface 90, as shown in FIG. 5A. In this scenario, the system can request additional information from the insured, such as verifying additional medical provider or claim data, step 58. The request interface 90 can display selected types of claim data, including by listing, by way of example, additional providers, such as doctors or nurses that may have been affiliated with the claim forming part of the claim data. Once displayed, the insured can select the providers, if any, that the insured recognizes, and then the insured can select or actuate one of the soft buttons 94. According to one embodiment, the soft buttons 94 can include a select provider button 94A that allows the insured to select the previously designated providers. The soft buttons 94 can also include a No Providers Recognized soft button 94B that the insured can select if none of the displayed providers are recognized by the insured. If the insured selects the soft button 94B, then the user interface generator 26 generates a fourth request interface 100 that includes a message 102 or displays other selected indicia that can inform the insured that the fraud analysis module 32 of the claim monitoring agency unit 12 can initiate a fraud investigation into the claim data, step 60. The interface 100 can also include a soft button 104 that when selected displays additional information about the fraud investigation.

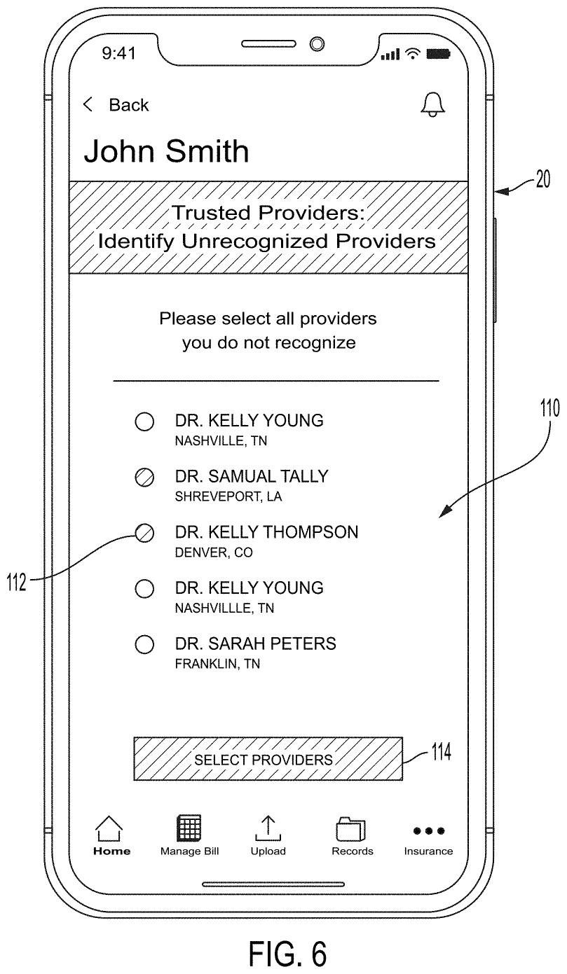

As shown in FIG. 3C, the claim monitoring agency unit 12 can then attempt to reverify or recertify the claim data with the insured so as to confirm that the information inputted by the insured during the initial portion of the verification process is accurate and trustworthy, step 62. The system 10 then once again attempts to determine if the claim data is correct, step 64. FIG. 6 illustrates a fifth request interface 110 that can be generated by the user interface generator 26 of the present invention. The interface 110 can include and display claim data 112 that can include once again a list of service providers, such as doctors and nurses, that can if desire form part of the claim data. The insured can once again select the providers that are recognized by the insured. The selection of the providers indicates that the insured is verifying that the displayed and selected claim data is accurate and correct. The interface 110 can also include a soft button 114 that the insured can select or actuate so as to verify the selection of the displayed providers. Those of ordinary skill in the art will readily recognize that the display can display any selected types of information, including any desired portion of the claim data, any selected healthcare data, insured data, insurance data, and the like. If all of the claim data is correct, then the selected providers are added to the insured profile and are logged as trusted providers, step 66. If any portion of the claim data is not correct, then the fraud analysis module 32 indicates that a fraud has occurred and initiates a fraud investigation and if desired an audit to be performed by the audit unit 28, step 68.

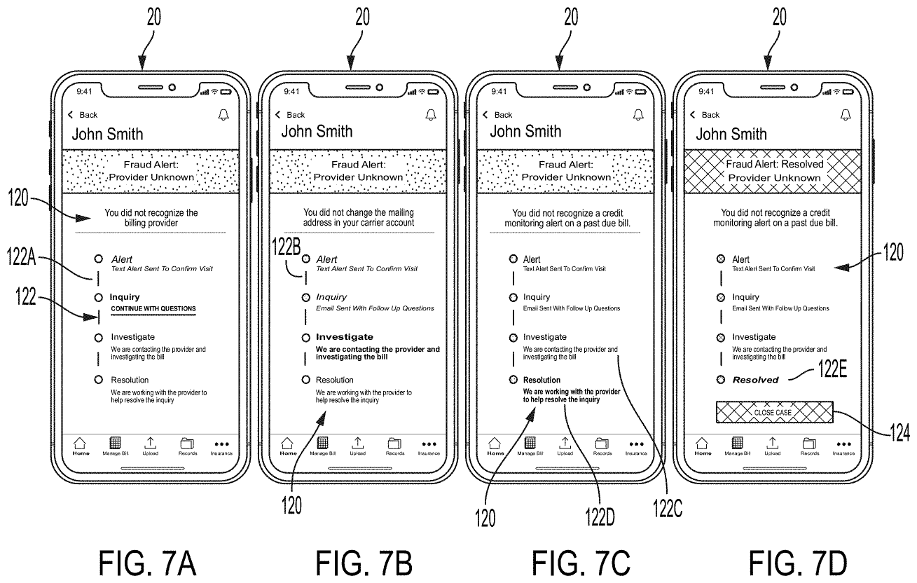

For a fraud investigation, the fraud analysis module 32 can communicate with the application 22 such that the user interface generator 26 generates the fraud interface 120, as shown in FIGS. 7A-7D. The fraud interface 120 can display selected indicia 122 that can be associated with the fraud investigation being performed by the fraud analysis module 32. The indicia 122 can include, for example, a predefined series of steps that the fraud analysis module 32 is performing and then communicating to the electronic device 20 so that the insured stays updated with regard to the status of the fraud investigation. As shown in FIG. 7A, the initial step 122A can include a basic alert notification that the fraud analysis module 32 has received the claim data and response from the insured and that the claim data has been flagged for further processing. When this occurs, the alert step 122A can be highlighted. The next step, as shown in FIG. 7B, provides information about an inquiry step 122B that is launched by the fraud analysis module 32, including for example sending via any suitable means questions regarding the claim data. Once this occurs, the inquiry step can be highlighted. Once the investigation is underway, the investigation step 122C can be highlighted, as shown in FIG. 7C. The investigation step 122C is indicative of the fraud analysis module 32 contacting the providers listed in the claim data. Once the provider is contacted and is engaged with the fraud analysis module 32 via for example, any suitable representative, then the interface 120 can be updated to highlight the resolution step 122D. As shown in FIG. 7D, once the matter is resolved, the interface is updated to reflect this, and the resolved step 122E can be highlighted. The interface 120 can also include a soft button 124 that allows the insured to close the case.

As part of the fraud investigation, the audit module 38 of the claim monitoring agency can perform an electronic (e.g., programmatic) or manual audit, or both, of the claim data. The review of the claim data enables the system to identify issues that may exist in the claim data. The audit can include contacting the medical service providers 24 and if needed the insurance provider to discuss the contents of the claim and to determine if the claim data is accurate. Those of ordinary skill will readily recognize that the audit unit can also form part of the claim monitoring agency unit 12 rather than being a separate element.

Thus, when the insured has disapproved any portion of the displayed claim data, the fraud analysis module 32 and/or the audit module 38 can initiate an investigation such that the claim forming part of the claim data can be electronically or manually reviewed. If the insured has approved the claim data, then the claim is programmatically analyzed using algorithms configured to detect fraud in the claim data regardless of whether the insured has approved the claim. Oftentimes, the insured may not understand the complex medical coding system and/or the services actually performed and represented in the claim. This process performed by the fraud analysis module 32 can separately and independently of the insured determine whether the programmatic analysis has detected fraud. If a fraud is detected, then the claim be manually or electronically investigated and/or an audit can be performed via the audit unit 28. If no fraud is detected, then authorization instructions are generated to pay the claim in accordance with preset policy parameters and the insured is contacted in known ways to inform the insured of the pay out and the amount the insured is obligated to pay.

During the claim validation portion of the process described herein, the insurance data provider unit 18 receives a claim from one or more medical service providers 24. The claims form part of the claim data that is processed by the insurance data provider unit 18 and then is sent to the claim monitoring agency unit 12 for verification, and if necessary, investigation of the claims in the claim data can be performed. Once the claim data is received by the claim monitoring agency unit 12, the unit 12 sends an alert the insured about claim submissions forming part of the claim data so that the insured can verify that the information (e.g., medical procedures) set forth in the claim are valid and accurate. According to one embodiment, the claim monitoring agency unit 12 communicates with the application 22 of the electronic device 20 of the insured. This methodology and preferred contact method can be established during the registration process. The insured can verify the accuracy of the claim data, and the claim monitoring agency unit 12 can further process and analyze the claim data for over-billing or other inconsistencies using a variety of known methods. For example, the medical code associated with a medical good or service is optionally programmatically compared against a database of stored time and billing ranges for a service or range of acceptable charges for the service. If the billed amount falls outside of the predefined range, then the claim monitoring agency unit 12 sends an alert that can prompt further investigation of the claim, such as for example by the audit module 38. In addition, claims are optionally examined for individual procedures that fall outside the scope of the treatment for that particular condition, such as a test for hepatitis being billed for the condition of a neck injury. This would also generate an alert prompting further investigation. Additionally, duplicate procedure billing is optionally conducted by analyzing dates against a database comprising generally accepted intervals between procedures being repeated. The claim monitoring agency unit 12 can programmatically identify duplicate billing that would generate an alert prompting further investigation of the claim. According to another embodiment, a scoring system can be optionally employed that weights and counterweights the above fraud and over billing detection methods giving the overall claim a score with a threshold beyond which the claim would prompt further investigation even if individually the above procedures didn't signal an alert.

When the initial alert is sent to the insured, the process can be established whereby a further request for confirmation of service is made after a predetermined period of time has elapsed. Following the lapse of the predetermined time, and it is determined that the insured has approved the claim, disapproved the claim, or did not respond, the claim can be examined by the fraud analysis module 32 and flagged as valid or worthy of audit. Specifically, the fraud analysis module 32 analyzes the claim data against any prestored insurance policy specification or information, the insured's profile or history, as well as other prestored data, so as to properly evaluate the claim data and if desired the overall benefit usage.

As described herein, the claim monitoring agency unit 12 can analyze the claim to determine whether the claim needs to be audited. That is, the analysis performed by the fraud analysis module 32 may result in the claim being flagged for remediation. For example, the explanation of benefits (EOB) set forth in the claim data can be scrutinized. Initially, the EOB can be processed to see if the EOB contains keywords, such as “emergency” or “surgery”. If the EOB contains such keywords, then the fraud analysis module 32 can indicate that an audit may be productive. Further, the fraud analysis module 32 can analyze the claim data to look for any identical descriptions of type of service. Such duplicates may be indicative of duplicative billing or excessive procedures. If such duplicates are found, then the claim can be flagged for audit.

It is to be understood that although the invention has been described above in terms of particular embodiments, the foregoing embodiments are provided as illustrative only, and do not limit or define the scope of the invention. Various other embodiments, including but not limited to those described herein are also within the scope of the claims. For example, elements, units, tools and components described herein may be further divided into additional components or joined together to form fewer components for performing the same functions.

Any of the functions disclosed herein may be implemented using means for performing those functions. Such means include, but are not limited to, any of the components or units disclosed herein, such as the electronic or computing device components described herein.

The techniques described above and below may be implemented, for example, in hardware, one or more computer programs tangibly stored on one or more computer-readable media, firmware, or any combination thereof. The techniques described above may be implemented in one or more computer programs executing on (or executable by) a programmable computer or electronic device having any combination of any number of the following: a processor, a storage medium readable and/or writable by the processor (including, for example, volatile and non-volatile memory and/or storage elements), an input device, an output device, and a display. Program code may be applied to input entered using the input device to perform the functions described and to generate output using the output device.

The term computing device or electronic device as used herein can refer to any device that includes a processor and a computer-readable memory capable of storing computer-readable instructions, and in which the processor is capable of executing the computer-readable instructions in the memory, examples of which include servers, client devices, computers, smartphones, switches, and the like. The terms computer system and computing system refer herein to a system containing one or more computing devices.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which affirmatively require a computer, a computing device, an electronic device, a processor, a memory, storage, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to determine the lineage of business terms and application interfaces between multiple software applications. There is no analog to this problem in the non-computer environment, nor is there an analog to the solutions disclosed herein in the non-computer environment.

Furthermore, embodiments of the present invention represent improvements to computer and communication technology itself. For example, the system 10 of the present can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

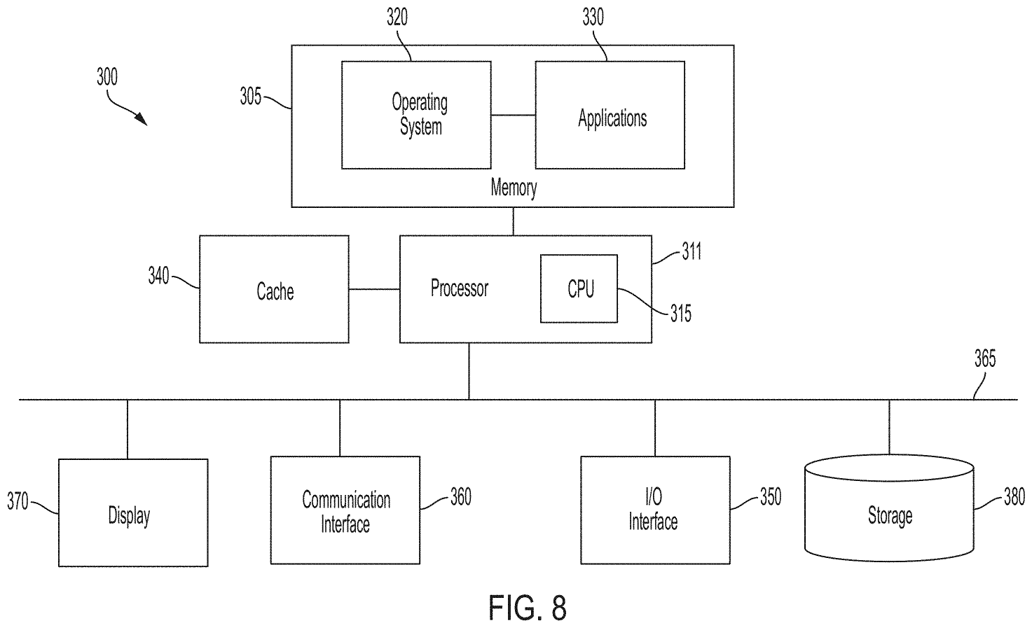

It should be appreciated that various concepts, systems and methods described above can be implemented in any number of ways, as the disclosed concepts are not limited to any particular manner of implementation or system configuration. Examples of specific implementations and applications are discussed below and shown in FIG. 8 primarily for illustrative purposes and for providing or describing the operating environment of the system of the present invention. The claim monitoring system 10 and/or elements or units thereof can employ one or more electronic or computing devices, such as one or more servers, clients, computers, laptops, smartphones and the like, that are networked together or which are arranged so as to effectively communicate with each other. The network can be any type or form of network. The devices can be on the same network or on different networks. In some embodiments, the network system may include multiple, logically-grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like, such as the illustrated electronic or computing device 300. The system 10 or any associated units, modules, or components of the system 10 can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device 300. In one embodiment, the server may be referred to as a remote machine or a node. In another embodiment, a plurality of nodes may be in the path between any two communicating servers or clients. The data identification system 10 which includes the data extraction unit 14, the storage unit 18, the application model unit 24, the object generation unit 28, the term identification unit 30, the mapping unit 32, the term lineage determination unit 36 and the user interface generator 38 (elements of the system) can be stored on or implemented by one or more of the electronic devices described herein (e.g., clients or servers), and the hardware associated with the electronic devices, such as the processor or CPU and memory described below.

FIG. 8 is a high-level block diagram of an electronic or computing device 300 that can be used with the embodiments disclosed herein. Without limitation, the hardware, software, and techniques described herein can be implemented in digital electronic circuitry or in computer hardware that executes firmware, software, or combinations thereof. The implementation can include a computer program product (e.g., a non-transitory computer program tangibly embodied in a machine-readable storage device, for execution by, or to control the operation of, one or more data processing apparatuses, such as a programmable processor, one or more computers, one or more servers and the like). As such, the claim monitoring agency unit 12, the insurance data provider unit 18, and the electronic device 20 can all employ one or more electronic devices.

The illustrated electronic device 300 can be any suitable electronic circuitry that includes a main memory unit 305 that is connected to a processor 311 having a CPU 315 and a cache unit 340 configured to store copies of the data from the most frequently used main memory 305. The electronic device can implement the process flow identification system 10 or one or more elements of the process flow identification system.

Further, the methods and procedures for carrying out the methods disclosed herein can be performed by one or more programmable processors executing a computer program to perform functions of the invention by operating on input data and generating output. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 311 is any logic circuitry that responds to, processes or manipulates instructions received from the main memory unit, and can be any suitable processor for execution of a computer program. For example, the processor 311 can be a general and/or special purpose microprocessor and/or a processor of a digital computer. The CPU 315 can be any suitable processing unit known in the art. For example, the CPU 315 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 311 can be embodied in any suitable manner. For example, the processor 311 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 311 can be configured to execute instructions stored in the memory 305 or otherwise accessible to the processor 311. As such, whether configured by hardware or software methods, or by a combination thereof, the processor 311 can represent an entity (e.g., physically embodied in circuitry) capable of performing operations according to embodiments disclosed herein while configured accordingly. Thus, for example, when the processor 311 is embodied as an ASIC, FPGA or the like, the processor 311 can be specifically configured hardware for conducting the operations described herein. Alternatively, as another example, when the processor 311 is embodied as an executor of software instructions, the instructions can specifically configure the processor 311 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor can be configured to receive and execute instructions received from the main memory 305.

The electronic device 300 applicable to the hardware of the present invention can be based on any of these processors, or any other processor capable of operating as described herein. The central processing unit 315 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

The processor 311 and the CPU 315 can be configured to receive instructions and data from the main memory 305 (e.g., a read-only memory or a random access memory or both) and execute the instructions. The instructions and other data can be stored in the main memory 305. The processor 311 and the main memory 305 can be included in or supplemented by special purpose logic circuitry. The main memory unit 305 can include one or more memory chips capable of storing data and allowing any storage location to be directly accessed by the processor 311. The main memory unit 305 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 305 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 305 can be based on any of the above described memory chips, or any other available memory chips capable of operating as described herein. In the embodiment shown in FIG. 4, the processor 311 communicates with main memory 305 via a system bus 365. The computer executable instructions of the present invention may be provided using any computer-readable media that is accessible by the computing or electronic device 300. Computer-readable media may include, for example, the computer memory or storage unit 305. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 305 is shown within the computing device 300 it will be appreciated that the storage may be distributed or located remotely and accessed via a network or other communication link.

The main memory 305 can comprise an operating system 320 that is configured to implement various operating system functions. For example, the operating system 320 can be responsible for controlling access to various devices, memory management, and/or implementing various functions of the asset management system disclosed herein. Generally, the operating system 320 can be any suitable system software that can manage computer hardware and software resources and provide common services for computer programs.

The main memory 305 can also hold application software 330. For example, the main memory 305 and application software 330 can include various computer executable instructions, application software, and data structures, such as computer executable instructions and data structures that implement various aspects of the embodiments described herein. For example, the main memory 305 and application software 330 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 311 can further be coupled to a database or data storage 380. The data storage 380 can be configured to store information and data relating to various functions and operations of the content characterization systems disclosed herein. For example, as detailed above, the data storage 380 can store information including but not limited to captured information, multimedia, processed information, and characterized content.

A wide variety of I/o devices may be present in or connected to the electronic device 300. For example, the electronic device can include a display 370, and as previously described, the visual application unit 28 or one or more other elements of the system 10 can include the display. The display 370 can be configured to display information and instructions received from the processor 311. Further, the display 370 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 370 can be a smart and/or touch sensitive display that can receive instructions from a user and forwarded the received information to the processor 311. The input devices can also include user selection devices, such as keyboards, mice, trackpads, trackballs, touchpads, touch mice, multi-touch touchpads, touch mice and the like, as well as microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 300 can also include an Input/Output (I/O) interface 350 that is configured to connect the processor 311 to various interfaces via an input/output (I/O) device interface 380. The device 300 can also include a communications interface 360 that is responsible for providing the circuitry 300 with a connection to a communications network (e.g., communications network 120). Transmission and reception of data and instructions can occur over the communications network.

1. A computer-implemented method of verifying claim data, comprising
receiving the claim data having a claim associated therewith from a data source,
analyzing the claim to assess the accuracy thereof,
sending a verification request to an insured associated with the claim requesting that the insured verify the accuracy of selected portions of the claim,
receiving verification information from the insured in response to the verification request,
programmatically assessing the verification information from the insured,
if the insured verifies the accuracy of the selected portions of the claim, programmatically updating a profile associated with the insured to include the verification information, and then programmatically sending authorization instructions regarding payment of the claim, and
if the insured does not verify the accuracy one or more portions of the selected portions of the claim, then programmatically initiating a fraud investigation of the portions of the claim that are inaccurate.

2. The computer-implemented method of claim 1, wherein the data source is from an insurance data provider or a medical service provider.

3. The computer-implemented method of claim 1, wherein the claim data comprise insurance data, insured data, and healthcare data.

4. The computer-implemented method of claim 1, further comprising receiving registration data from the insured and storing the registration data in the profile.

5. The computer-implemented method of claim 4, wherein the registration data comprises insured data including identification information, insurance data including at least one insurance company handling insurance for the insured, and login credentials including a user identification.

6. The computer-implemented method of claim 1, further comprising, during the fraud investigation, analyzing the claim data and the verification information to determine whether the claim is accurate and to determine whether fraudulent activity has occurred.

7. The computer-implemented method of claim 1, further comprising reverifying the claim data with the insured so as to confirm that the verification information is accurate.

8. The computer-implemented method of claim 7, further comprising auditing the claim based on the results of the fraud investigation.

9. The computer-implemented method of claim 8, wherein the data source includes a medical service provider and an insurance company, further comprising, during the auditing step, verifying the claim data associated with the claim by contacting the service provider and the insurance company to determine the accuracy of the claim data.

10. The computer-implemented method of claim 1, further comprising providing a mobile software application having a user interface generator for generating a first request interface in response to the verification request, wherein the first request interface displays the selected portions of the claim data and a plurality of selectable soft buttons that requests selected information from the insured, wherein a first one of the plurality of soft buttons when actuated transmits the verification information indicating that the selected portions of the claim are accurate, and wherein a second one of the plurality of soft buttons when actuated transmits the verification information indicating that selected portions of the claim are inaccurate.

11. The computer-implemented method of claim 10, wherein when the first one of the plurality of soft buttons is actuated, generating a second request interface for displaying confirmation information confirming selections made by the insured and at least one second soft button such that when actuated the second request interface display additional information associated with the claim.

12. The computer-implemented method of claim 11, wherein when the second one of the plurality of soft buttons is selected, generating a third request interface with the user interface generator for displaying the selected portions of the claim data including service provider information, requesting additional verification information from the insured, and displaying a plurality of third soft buttons having a first soft button for allowing when actuated the insured to confirm selection of one or more of the service providers and a second soft button for allowing when actuated the insured to indicate that one or more the service providers is inaccurate.

13. The computer-implemented method of claim 12, wherein when the second soft button of the plurality of third soft buttons is actuated, generating a fourth request interface with the user interface generator for displaying message information concerning the claim and the fraud investigation and one or more fourth soft buttons that when selected displays additional information about the fraud investigation.

14. The computer-implemented method of claim 13, further comprising generating a fifth user interface for displaying selected claim information and requesting reverification of the claim information.

15. The computer-implemented method of claim 14, wherein when the fraud investigation is initiated, generating a fraud interface with the user interface generator for displaying selected fraud information associated with the fraud investigation, wherein the fraud information includes a plurality of steps and the fraud interface displays the selected steps of the fraud investigation that have been completed.

16. A non-transitory computer-readable storage medium storing instructions that when executed causes one or more processors to:
generate a first request interface in response to a verification request, wherein the first request interface displays selected portions of claim data about an insured and a plurality of selectable soft buttons that requests selected information from the insured, wherein a first one of the plurality of soft buttons when actuated transmits verification information indicating that the selected portions of the claim are accurate, and wherein a second one of the plurality of soft buttons when actuated transmits the verification information indicating that selected portions of the claim are inaccurate,
wherein when the first one of the plurality of soft buttons is actuated, generating a second request interface for displaying confirmation information confirming selections made by the insured and at least one second soft button such that when actuated the second request interface display additional information associated with the claim,
wherein when the second one of the plurality of soft buttons is selected, generating a third request interface for displaying the selected portions of the claim data including service provider information, requesting additional verification information from the insured, and displaying a plurality of third soft buttons having a first soft button for allowing when actuated the insured to confirm selection of one or more of the service providers and a second soft button for allowing when actuated the insured to indicate that one or more the service providers is inaccurate,
wherein when the second soft button of the plurality of third soft buttons is actuated, generating a fourth request interface for displaying message information concerning the claim and the fraud investigation and one or more fourth soft buttons that when actuated displays additional information about the fraud investigation.

17. The non-transitory computer-readable storage medium of claim 16, further comprising generating a fifth user interface for displaying selected claim information and requesting reverification of the claim information.

18. The non-transitory computer-readable storage medium of claim 17, wherein when the fraud investigation is initiated, generating a fraud interface with the user interface generator for displaying selected fraud information associated with the fraud investigation, wherein the fraud information includes a plurality of steps and the fraud interface displays the selected steps of the fraud investigation that have been completed.
